(19) United States
(12) Patent Application Publication
(10) Pub. No.: US 2024/0410626 A1
(43) Pub. Date: Dec. 12, 2024

(54) SORPTION HEAT PUMP AND SORPTION CYCLE

(71) Applicant: AGO GmbH Energie + Anlagen, Kulmbach (DE)

(72) Inventor: Klaus Ramming, Mainleus (DE)

(21) Appl. No.: 18/593,707

(22) Filed: Mar. 1, 2024

(30) Foreign Application Priority Data
Mar. 2, 2023 (EP) EP23159593.5

(51) Int. Cl. F25B 30/04

(52) U.S. Cl. CPC F25B 30/04

(57) ABSTRACT

A sorption heat pump with a gaseous refrigerant and a liquid solvent, with a enriched solution and a rich solution, which are one phase mixes of the solvent and the refrigerant, with an absorption unit in which a first partial flow of the solvent absorbs a medium-pressure partial flow of the refrigerant in a medium-pressure absorber at a medium pressure level and a second partial flow of the solvent absorbs a high-pressure partial flow of the refrigerant in a high-pressure absorber at a high-pressure level, and wherein the first partial flow and the second partial flow emit respective absorption generated heat to a heat sink outside of the sorption heat pump, and with an expeller in which the rich solution from the absorption unit absorbs heat at a low pressure level from a heat source outside of the sorption heat pump and thus expels the refrigerant.

### RELATED APPLICATIONS

This application claims priority from and incorporates by reference European patent application 23 159 593.5 filed on Mar. 2, 2023.

### FIELD OF THE INVENTION

The invention relates to a sorption heat pump with a gaseous refrigerant and a liquid solvent.

### BACKGROUND OF THE INVENTION

A generic sorption heat pump and a generic sorption cycle are known from EP 3 964 770 A1 and EP 3 540 332 A1. Therein it is proposed to initially pump the solvent and the refrigerant from the low pressure level to the high-pressure level and feed the solvent and the refrigerant to the high-pressure absorber and to branch off the medium pressure partial flow upstream of the high-pressure absorber and to expand the medium pressure partial flow to the medium pressure level so that the solvent initially only absorbs the remaining high-pressure partial flow and the enriched solution thus created subsequently absorbs the medium pressure partial flow in the medium pressure absorber.

### BRIEF SUMMARY OF THE INVENTION

Thus, it is an object of the invention to reduce an amount of energy that is required to reach the high-pressure level.

The object is achieved by a sorption heat pump, including a gaseous refrigerant and a liquid solvent; an enriched solution and a rich solution which are one phase mixes of the solvent and the refrigerant; an absorption unit in which a first partial flow of the solvent absorbs a medium-pressure partial flow of the refrigerant in a medium-pressure absorber at a medium pressure level, and a second partial flow of the solvent absorbs a high-pressure partial flow of the refrigerant in a high-pressure absorber at a high-pressure level, and wherein the first partial flow and the second partial flow emit respective absorption generated heat to a heat sink outside of the sorption heat pump; an expeller in which the rich solution from the absorption unit absorbs heat at a low-pressure level from a heat source outside of the sorption heat pump and thus expels the refrigerant; an expansion valve which expands the rich solution from the high-pressure level to the low-pressure level after exiting the absorption unit and before entering the expeller; a pump and a compressor that pump the solvent and the refrigerant from the low-pressure level to the medium pressure level after exiting the expeller; an intermediary compressor that compresses the high-pressure partial flow of the refrigerant from the medium pressure level to the high-pressure level and that feeds the high-pressure partial flow of the refrigerant at the high-pressure level into the high-pressure absorber; and an intermediary pump that pumps the enriched solution exiting from the medium pressure absorber to the high-pressure level and feeds the enriched solution at the high-pressure level into the high-pressure absorber.

The object is also achieved by a sorption cycle of the sorption heat pump, the sorption cycle including: a gaseous refrigerant and a liquid solvent, an enriched solution and a rich solution, which are one phase mixes of the solvent and the refrigerant, the sorption cycle including a first partial flow of the solvent absorbing a medium-pressure partial flow of the refrigerant at a medium pressure level and a second partial flow of the solvent absorbing a high-pressure partial flow of the refrigerant at a high-pressure level, and the first partial flow and the second partial flow emitting respective absorption generated heat to a heat sink outside of the sorption cycle; the rich solution generated by absorbing the refrigerant being expanded to a low-pressure level and absorbing heat from a heat source outside of the sorption cycle and thus expelling the refrigerant; the solvent and the refrigerant being pumped from the low-pressure level to the medium pressure level; only the high-pressure partial flow of the refrigerant being compressed from the medium pressure level to the high-pressure level; and the solution enriched by the medium pressure partial flow being pumped from the medium pressure level to the high-pressure level.

The sorption heat pump according to the invention absorbs heat at a low temperature level and emits the heat again at a higher temperature level. The rich solution cools in the expansion valve and can thus absorb the low temperature heat. The gaseous refrigerant and the liquid solvent are fed to the absorption unit separately.

An amount of the refrigerant that is compressed in a gaseous state to the high-pressure level in the sorption heat pump according to the invention is reduced by the medium pressure partial flow compared to the prior art. The energy saved is higher than the additional energy required for pumping the additional mass flow of the enriched solution to the high-pressure level. The additional energy required for pumping the solution that is enriched by the medium pressure partial flow is less than the energy required for compressing the medium pressure partial flow.

Advantageously the sorption heat pump according to the invention includes an intercooler where the high-pressure partial flow of the refrigerant emits heat at the medium pressure level. Many heat pump applications require a two-stage refrigerant compression and inter cooling of the vapor between the compressors in order to reach the required pressure ratio without the refrigerant vapor becoming excessively hot during the compression.

In particular the enriched solution can absorb heat in the intercooler at the high-pressure level. The enriched solution cools the high-pressure partial flow and supplies the absorbed heat to the heat sink in the high-pressure absorber in the sorption heat pump according to the invention.

Advantageously a sorption heat pump according to the invention includes a solution heat exchanger in which one of the partial flows absorbs heat from the rich solution at the high-pressure level. The absorbed heat is then available to the heat sink in the medium pressure absorber. In particular the solvent can absorb the heat at the medium pressure level.

Advantageously a sorption heat pump according to the invention includes an additional absorber connected in parallel with the high-pressure absorber wherein one of the partial flows absorbs heat from the rich solution at the high-pressure level in the additional absorber. When the spread, thus the temperature difference between the entry of the heat carrier into the sorption heat pump and the exit of the heat carrier from the sorption heat pump, is significantly greater at the heat sink, than at the heat source, the heat carrier of the heat sink can be preheated to a medium temperature level in the medium pressure absorber. The solution enriched in the medium pressure absorber is thus almost cooled down to an entry temperature of the heat sink. Before entering the high-pressure absorber the solution is heated to the exit temperature of the heat sink in a sorption heat pump according to the invention. In particular the enriched solution can absorb the heat at the high-pressure level.

Advantageously the medium pressure absorber and/or the high-pressure absorber are plate heat exchangers in the sorption heat pump according to the invention. Absorbers of this type have a simple configuration, require little maintenance and are economically available in the market in great variety.

Advantageously the solvent in a sorption heat pump according to the invention is water and the refrigerant is ammonia. Water and ammonia are natural substances and well proven in refrigeration applications.

According to claim 7 the sorption cycle according to the invention runs in a sorption heat pump according to the invention and is characterized by its advantages described supra.

Advantageously a heat carrier of the heat sink is divided into two partial flows run in parallel in a sorption cycle according to the invention and heat generated by absorbing the medium pressure partial flow is transferred to a first partial flow of the two partial flows and heat generated by absorbing the high-pressure partial flow is transferred to a second partial flow of the two partial flows and the two partial flows are subsequently combined again. A maximum size medium pressure partial flow is absorbed at the medium pressure level and heat generated in this process is emitted to the heat carrier of the heat sink in order to generate steam therein wherein quite different temperature spreads are provided at the heat source and at the heat sink in the sorption cycle according to the invention. In order for the relatively dry refrigerant not to get saturated with the solvent in the medium pressure absorber, the medium pressure absorber is only provided with an amount of refrigerant that can be absorbed. Only the remaining refrigerant is run to the high-pressure absorber.

In an advantageous alternative, heat generated by absorbing the medium pressure partial flow is initially emitted to a heat carrier of the heat sink and subsequently heat generated by absorbing the high-pressure partial flow is emitted to the heat carrier of the heat sink in a sorption cycle according to the invention. When the spread at the heat sink is much greater than the spread at the heat source the heat carrier of the heat sink is preheated in the medium pressure absorber and only heated to the desired exit temperature in the high-pressure absorber.

Advantageously the solvent is divided into the first partial flow and the second partial flow in a sorption cycle according to the invention. The first partial flow does not have to be pumped to the high-pressure level anymore after absorbing the medium pressure partial flow.

### BRIEF DESCRIPTION OF THE DRAWINGS

The invention is subsequently described based on embodiments with reference to drawing figures, wherein:

FIG. 1 illustrates a first sorption heat pump according to the invention;

FIG. 2 illustrates a second sorption heat pump according to the invention; and

FIG. 3 illustrates a third sorption heat pump according to the invention.

### DETAILED DESCRIPTION OF THE INVENTION

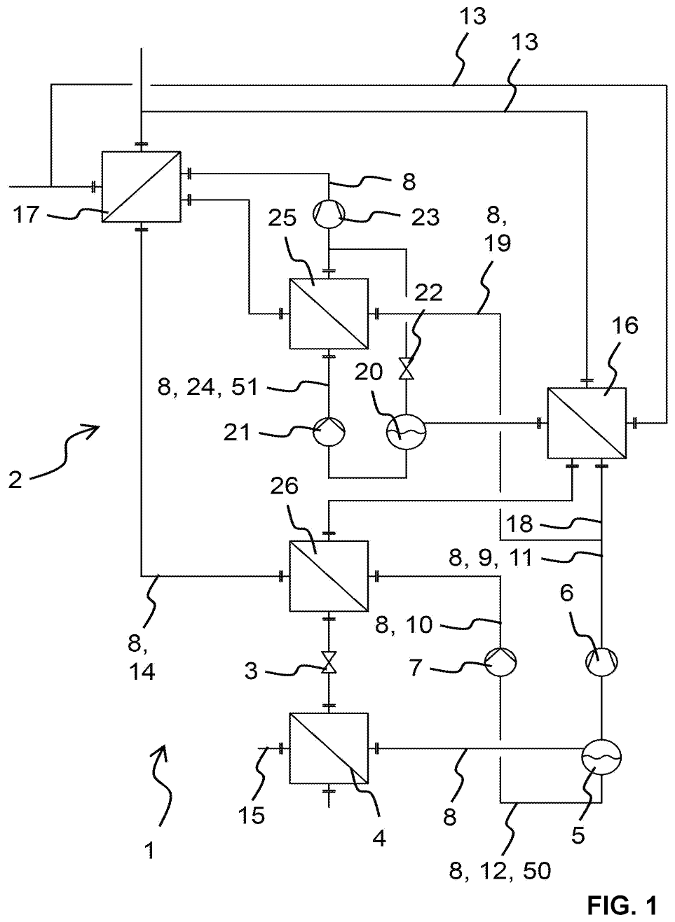

The first sorption heat pump 1 according to the invention shown in FIG. 1 includes an absorption unit 2, an expansion valve 3 an expeller 4, a separator 5, a compressor 6, a pump 7 and conduits 8 that connect the elements recited supra in the sequence recited supra to form a closed loop system, wherein the compressor 6 is arranged in a refrigerant path 9 and the pump 7 is arranged in a solvent path 10 running parallel to the refrigerant path and from the precipitator 5 to the absorption unit 2.

In a cycle of the sorption cycle process according to the invention including ammonia (NH₃) as a refrigerant 11 in water as a solvent 12, a flow of 3.3 kg/s of the solvent 12 absorbs a flow of 3.2 kg/s of the refrigerant 11 in the absorption unit 2 and emits heating power to a heat sink. Feed water entering the absorption unit 2 at 100° C., functioning as a heat carrier 13 of the heat sink exits from the absorption unit 2 at 110° C. as a saturated vapor. A flow of rich solution 14, exiting at 87° C. at a high-pressure level of 48 bar from the absorption unit 2 at 6.5 kg/s is expanded by the expansion valve 3 to a low-pressure level of 6 bar and heated in the expeller 4 by a heat source with a power of 2610 KW to 64° C. The heat carrier 15 of the heat source entering the expeller 4 at 70° C. is thus cooled to 30° C. The flow of the solvent 12 is fed from the subsequent separator 5 by the pump 7 to a medium pressure level of 22 bar and fed into the absorption unit 2 and the flow of the refrigerant 11 is pumped by the compressor 6 to the medium pressure level of 22 bar and fed into the absorption unit.

The absorption unit 2 includes a medium pressure absorber 16 and a high-pressure absorber 17. The heat carrier 13 of the heat sink is initially divided into two partial flows before entering the medium pressure absorber 16 and the high-pressure absorber 17, the medium pressure absorber 16 and the high-pressure absorber 17 are flowed through in parallel by the partial flows and after exiting the medium pressure absorber 16 and the high-pressure absorber 17 the partial flows are combined again. The refrigerant 11 entering the absorption unit 2 at the medium pressure level at 160° C. is initially divided into a medium pressure partial flow 18 and a high-pressure partial flow 19. A first partial flow 50 of the solvent 12 absorbs the medium pressure partial flow 18 in the medium pressure absorber 16 and thus emits a heating power of 303 KW to the heat carrier 13 of the heat sink.

The absorption unit 2 includes a medium pressure separator 20, an intermediary pump 21, an expansion valve 22 and an intermediary compressor 23. An enriched solution 24 exiting from the medium pressure absorber 16 at 110° C. initially separates non-absorbed refrigerant 11 in the medium pressure absorber 20 and is pumped by the intermediary pump 21 in a second partial flow 51 to the high-pressure level and pumped at 3.7 kg/s into the high-pressure absorber 17. The refrigerant 11 from the medium pressure separator 20 is joined with the high-pressure partial flow 19 through the expansion valve 22 and the refrigerant 11 and the high-pressure partial flow 19 are jointly compressed to the high-pressure level in the intermediary compressor 23 and thus heated from 84° C. to 155° C. and provided to the high-pressure absorber 17 at 2.8 kg/s.

The absorption unit 2 includes an intercooler 25 and a solution heat exchanger 26. The high-pressure partial flow 19 of the refrigerant 11 emits heat at the medium pressure level to the enriched solution 24 at the high-pressure level in the intermediary cooler 25 and heats the enriched solution 126° C. The solvent 12 at the medium pressure level absorbs heat from the rich solution at the high-pressure level in the solution heat exchanger 26.

The expeller 4 the medium pressure absorber 16, the high-pressure absorber 17, the intercooler 25 and the solution heat exchanger 26 are plate heat exchangers.

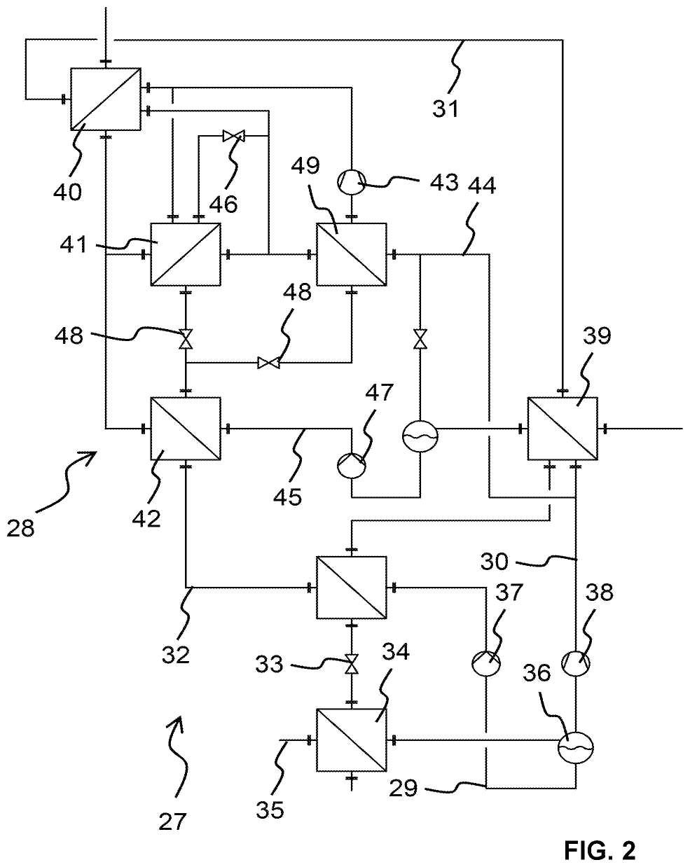

The second sorption heat pump 27 according to the invention shown in FIG. 2 and the sorption cycle according to the invention performed therein substantially correspond to the first sorption heat pump 1. A flow of 6.7 kg/s of the solvent 29 absorbs a flow of 3.9 kg/s of the refrigerant 30 in a cycle of the absorption unit 28 of the second sorption heat pump 27. The heat carrier 31 of the heat sink enters the absorption unit 28 at 60° C. A flow of the rich solution 32 that exits the absorption unit 28 at 11.2 kg/s at 52° C. at a high-pressure level of 45 bar is expanded by the expansion valve 33 to a low pressure of 7.3 bar and heated in the expeller 34 with a power of 4, 130 KW to 38° C. The heat carrier 35 of the heat sink entering the expeller 34 at 40° C. is thus cooled to 35° C. The flow of the solvent 29 is pumped from the subsequent separator 36 by the pump 37 to a medium pressure level of 28 bar, and fed into the absorption unit 28, and the flow of the refrigerant 30 is pumped by the compressor 38 to a medium pressure level of 28 bar and fed into the absorption unit 28.

Differently from the first sorption heat pump 1 the heat carrier 31 of the heat sink is initially preheated in the medium pressure absorber 39 with a heating power of 2,047 kW to 78° C. and subsequently heated in the high-pressure absorber 40 with a heating power of 3,464 KW to the exit temperature. Additionally, the second sorption heat pump 27 includes an additional absorber 41, and an additional solution heat exchanger 42.

The high-pressure partial flow 44 of the refrigerant 30 exiting the intermediary compressor 43 at 155° C. and the enriched solution 45 are divided upstream of the high-pressure absorber 40 and run in two partial flows in parallel through the high-pressure absorber 40 and the additional absorber 41, the respective exiting partial flows of the rich solution 32 are subsequently joined again. The partial flow of the enriched solution 45 in the additional absorber 41 is controlled by an expansion valve 46. Downstream of the intermediary pump 47 the flow of the enriched solution 45 exiting from the medium pressure absorber 39 at 7.3 kg/s at 63° C. is initially heated to 97° C. at the high-pressure level in the additional solution heat exchanger 42 by the rich solution 32. The enriched solution 45 is then separated, and controlled by two expansion valves 48 in two partial flows of 3.65 kg/s and heated in parallel in the intercooler 49 to 112° C. and heated in the additional absorber 41 to 107° C., combined again and run at 110° C. into the high-pressure absorber 40 and the additional absorber 41.

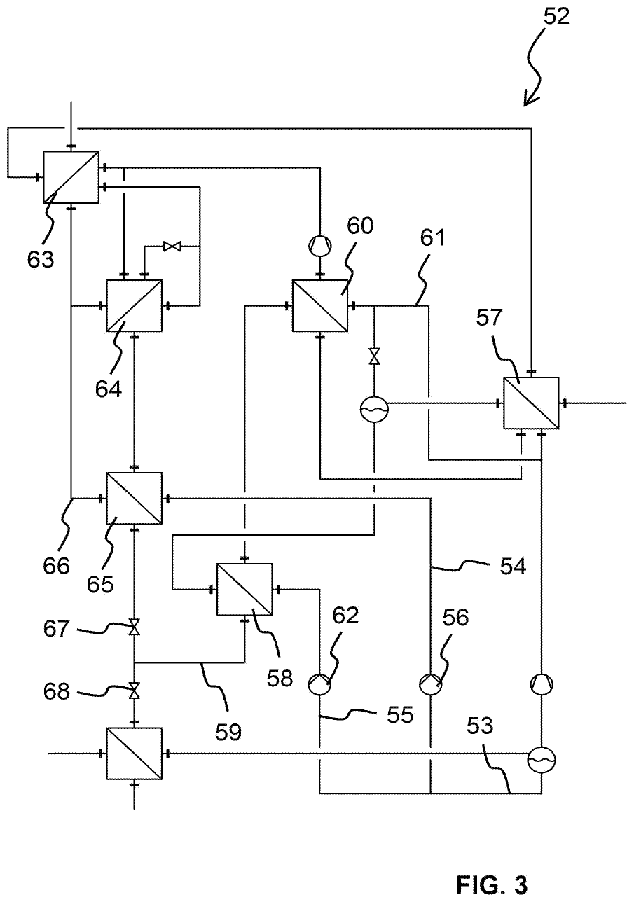

The third sorption heat pump 52 according to the invention shown in FIG. 3 and the sorption cycle according to the invention running therein essentially correspond to the second sorption heat pump 27. Differently from the second sorption heat pump, however, the solvent 53 is divided into a first partial flow 54 and a second partial flow 55.

The first partial flow 54 is pumped to the medium pressure level by a first pump 56 and fed to the medium pressure absorber 57. Upstream of the medium pressure absorber 57, the first partial flow 54 of the solvent 53 absorbs heat in a solution heat exchanger 58 from the rich solution 59 from the medium pressure absorber 57 and absorbs heat in the intercooler 60 from the high-pressure partial flow 61.

The second partial flow 55 is pumped to the high-pressure level by a second pump 62 and fed to the high-pressure absorber 63 and to the additional absorber 64. The second partial flow 55 absorbs heat from the rich solution 66 from the high-pressure absorber 53 and the additional absorber 54 at the high-pressure level in an additional solution heat exchanger 65.

The rich solution 66 from the high-pressure absorber 63 and the additional absorber 64 is initially expanded to the medium pressure level in an intermediary expansion valve 67, combined with the rich solution 59 from the medium pressure absorber and only then expanded to the low-pressure level in the expansion valve 68.

### REFERENCE NUMERALS AND DESIGNATIONS

1 sorption heat pump
2 absorption unit
3 expansion valve
4 expeller
5 separator
6 compressor
7 pump
8 conduit
9 refrigerant path
10 solvent path
11 refrigerant
12 solvent
13 heat carrier of heat sink
14 rich solution
15 heat carrier of heat source
16 medium pressure absorber
17 high-pressure absorber
18 medium pressure partial flow
19 high-pressure partial flow
20 medium pressure separator
21 intermediary pump
22 expansion valve
23 intermediary compressor
24 enriched solution
25 intercooler
26 solution heat exchanger
27 sorption heat pump
28 absorption unit
29 solvent
30 refrigerant
31 heat carrier of heat sink
32 rich solution
33 expansion valve
34 expeller
35 heat carrier of heat sink
36 separator
37 pump
38 compressor
39 medium pressure absorber
40 high-pressure absorber
41 additional absorber
42 additional solution heat exchanger
43 intermediary compressor
44 high-pressure partial flow
45 enriched solution
46 expansion valve
47 intermediary pump
48 expansion valve
49 intercooler
50 first partial flow of solvent
51 second partial flow of solvent
52 sorption heat pump
53 solvent
54 first partial flow of solvent
55 second partial flow of solvent
56 first pump
57 medium pressure absorber
58 solution heat exchanger
59 rich solution
60 intercooler
61 high-pressure partial flow
62 second pump
63 high-pressure absorber
64 additional absorber
65 solution heat exchanger
66 rich solution
67 intermediary expansion valve
68 expansion valve

What is claimed is:

1. A sorption heat pump, comprising:
a gaseous refrigerant and a liquid solvent;
an enriched solution and a rich solution which are one phase mixes of the solvent and the refrigerant;
an absorption unit in which a first partial flow of the solvent absorbs a medium-pressure partial flow of the refrigerant in a medium-pressure absorber at a medium pressure level, and a second partial flow of the solvent absorbs a high-pressure partial flow of the refrigerant in a high-pressure absorber at a high-pressure level, and wherein the first partial flow and the second partial flow emit respective absorption generated heat to a heat sink outside of the sorption heat pump;
an expeller in which the rich solution from the absorption unit absorbs heat at a low-pressure level from a heat source outside of the sorption heat pump and thus expels the refrigerant;
an expansion valve which expands the rich solution from the high-pressure level to the low-pressure level after exiting the absorption unit and before entering the expeller;
a pump and a compressor that pump the solvent and the refrigerant from the low-pressure level to the medium pressure level after exiting the expeller;
an intermediary compressor that compresses the high-pressure partial flow of the refrigerant from the medium pressure level to the high-pressure level and that feeds the high-pressure partial flow of the refrigerant at the high-pressure level into the high-pressure absorber; and
an intermediary pump that pumps the enriched solution exiting from the medium pressure absorber to the high-pressure level and feeds the enriched solution at the high-pressure level into the high-pressure absorber.

2. The sorption heat pump according to claim 1, further comprising: an intercooler in which the high-pressure partial flow of the refrigerant emits heat at the medium pressure level to the enriched solution at the high-pressure level.

3. The sorption heat pump according to claim 1, further comprising: a solution heat exchanger in which one of the first partial flow of the solvent and the second partial flow of the solvent absorbs heat from the rich solution at the high-pressure level.

4. The sorption heat pump according to claim 1, further comprising: an additional absorber arranged parallel to the high-pressure absorber, wherein one of the first partial flow of the solvent and the second partial flow of the solvent absorbs heat at the high-pressure level in the additional absorber.

5. The sorption heat pump according to claim 1, wherein the medium pressure absorber and/or the high-pressure absorber are plate heat exchangers.

6. The sorption heat pump according to claim 1, wherein the solvent is water and the refrigerant is ammonia.

7. A sorption cycle of the sorption heat pump according to claim 1, the sorption cycle including a gaseous refrigerant and a liquid solvent, an enriched solution and a rich solution, which are one phase mixes of the solvent and the refrigerant, the sorption cycle comprising:
a first partial flow of the solvent absorbing a medium-pressure partial flow of the refrigerant at a medium pressure level and a second partial flow of the solvent absorbing a high-pressure partial flow of the refrigerant at a high-pressure level, and the first partial flow and the second partial flow emitting respective absorption generated heat to a heat sink outside of the sorption cycle;
the rich solution generated by absorbing the refrigerant being expanded to a low-pressure level and absorbing heat from a heat source outside of the sorption cycle and thus expelling the refrigerant;
the solvent and the refrigerant being pumped from the low-pressure level to the medium pressure level;
only the high-pressure partial flow of the refrigerant being compressed from the medium pressure level to the high-pressure level; and
the solution enriched by the medium pressure partial flow being pumped from the medium pressure level to the high-pressure level.

8. The sorption cycle according to claim 7,
wherein a heat carrier of the heat sink is divided into two partial flows run in parallel,
wherein heat generated by absorbing the medium pressure partial flow is emitted to a first partial flow of the two partial flows of the heat carrier and heat generated by absorbing the high-pressure partial flow is emitted to a second partial flow of the partial flows of the heat carrier, and
wherein the partial flows of the heat carrier are subsequently joined again.

9. The sorption cycle according to claim 7, wherein heat generated by absorbing the medium pressure partial flow is initially emitted to a heat carrier of the heat sink and subsequently heat generated by absorbing the high-pressure partial flow is emitted to the heat carrier of the heat sink.

10. The sorption cycle according to claim 7, wherein the solvent is divided into the first partial flow and the second partial flow.
